(19) United States
(12) Patent Application Publication
(10) Pub. No.: US 2007/0242712 A1
(43) Pub. Date: Oct. 18, 2007

(54) Semiconductor Laser Module and Method for Controlling the Same

(75) Inventor: Tomoyuki Funada, Yokohama-shi (JP)

Correspondence Address: FISH & RICHARDSON P.C., P.O. BOX 1022, MINNEAPOLIS, MN, 55440-1022, US

(73) Assignee: Sumitomo Electric Industries, Ltd.

(21) Appl. No.: 11/616,604

(22) Filed: Dec. 27, 2006

(30) Foreign Application Priority Data
Dec. 28, 2005 (JP) 378865/2005

(51) Int. Cl. H01S 3/04

(52) U.S. Cl. 372/36

(57) ABSTRACT

The present invention is to provide a laser module that includes a semiconductor laser diode that is raised in a temperature without degrading the heat dissipating efficiency to improve the operation and the performance of the laser diode. The laser module of the invention, having a co-axial package, includes a laser diode, and a heat sink on which the laser diode is mounted. The heat sink also provides a heater on a surface thereof. Supplying a heater current to the heater, the laser diode is raised in a temperature, which improves the operation on the laser diode at a lower ambient temperature.

### BACKGROUND OF THE INVENTION

1. Filed of the Invention

The present invention relates to a semiconductor laser module and a method for operating the module.

2. Related Prior Art

It has been known that, in an optical transmitter that provides a semiconductor laser diode (hereinafter denoted as LD) directly driven with a modulation signal, the operation of the LD often becomes unstable when the transmitter is necessary to operate in a wide temperature range. For example, in a case that a temperature range from −20° C. to +85° C. is necessary, it is often encountered that the optical output from the LD is degraded in relatively lower or higher temperatures due to large temperature dependence of various parameters of the LD such as emission wavelength, threshold current, slope efficiency and/or relaxation frequency of the LD.

Various methods and techniques have been studied and presented to solve the above subject. For example, the United States Patent, U.S. Pat. No. 5,740,191, has disclosed an optical transmitter that provides a heater attached to an outer surface of a stem to maintain a temperature of the module in a relatively high value at lower ambient temperatures, which enables to relax the large temperature dependence of the LD at low temperatures without installing a Peltier device. The arrangement disclosed in this United States patent has relatively large time constant from the heating up of the heater to a situation that the LD is fully heated because the heater is attached outside the package.

A Japanese Patent published as JP-2001-094200A has disclosed another technique for the laser module that realizes the stable performance in the emission wavelength of the laser module with a compact package, low cost and lower power consumption. The laser module disclosed in this Japanese Patent controls a temperature of the LD by a heater without an expensive Peltier device. That is, the module provides a heater put between the LD and the heat sink that mounts the LD thereon to heat up and to maintain the temperature of the LD constant. However, the arrangement of the heater shown in this Japanese patent shows inferior efficiency of the heat dissipation because the module in the patent puts the heater between the LD and the heat sink.

### SUMMARY OF THE INVENTION

One aspect of the present invention relates to a semiconductor laser module that includes a semiconductor laser diode (LD), a heat sink, and a heater. These components are enclosed within, what is called, a co-axial package. The heat sink that is made of an insulating material mounts the semiconductor laser diode thereon and provides the heater on the surface thereof.

The heater may be a thin film resistor made of, for instance, tantalum nitride (TaN), while the heat sink may be made of aluminum nitride (AlN). To supply a current to the heater heats up the LD to make an operation of the LD at lower temperatures in stable and reliable. The present invention disposes the LD and the heater both on the surface of the heat sink, accordingly, better thermal efficiency may be obtained comparing to an arrangement where the heater is disposed outside the package. Moreover, to arrange the heater on the surface of the heat sink may prevent the heat dissipating efficiency for the LD from degrading.

Another aspect of the present invention relates to a method for controlling a temperature of the laser module. The method includes steps of: (a) monitoring an ambient temperature of the laser module, (b) deciding whether the ambient temperature is within a preset temperature range or not, and (c) supplying a current to the heater when the ambient temperature is within the preset temperature range. The magnitude I of the current to be supplied to the heater may be given by;
I=A×(Th−Ta)^{1/2},
where A is a constant, Ta is the ambient temperature, Th is an higher limit of the preset temperature range. To supply the current to the heater may maintain the temperature of the LD even when the ambient temperature varies.

### BRIEF DESCRIPTION OF DRAWINGS

FIG. 1 is a cross section of a laser module according to the first embodiment of the invention, FIG. 1 is viewed from one direction;

FIG. 2 is a cross section taken along the line II-II shown in FIG. 1 and viewed from a direction perpendicular to that in FIG. 1;

FIG. 3 is a schematic diagram of the electrical connection within the laser module according to the first embodiment of the invention;

FIG. 4 is a block diagram of the optical transmitter including the optical module shown in FIG. 1 according to the first embodiment of the invention;

FIG. 5 is a block diagram showing an example of the temperature sensor block and the current source for the heater;

FIG. 6 shows a thermal equilibrium state of the laser module of the present invention;

FIG. 7 is a cross section viewed from the same direction with that of FIG. 2; and

FIG. 8 is a block diagram of the optical transmitter that includes the optical module shown in FIG. 7 according to the present invention.

### DESCRIPTION OF PREFERRED EMBODIMENTS

Next, preferred embodiments of the present invention will be described as referring to accompanying drawings. In the drawings, same elements will be referred by the same numerals or the symbols without overlapping explanations.

### First Embodiment

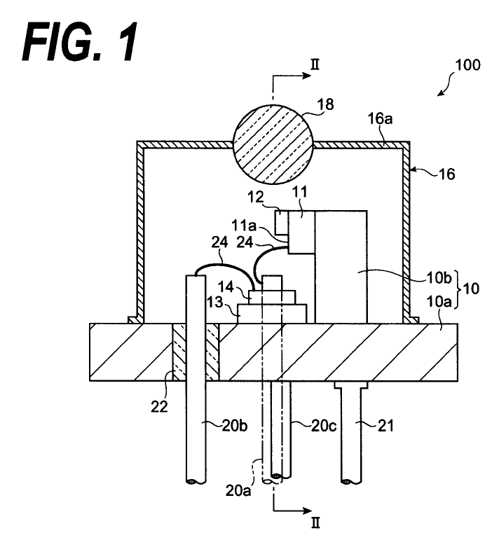

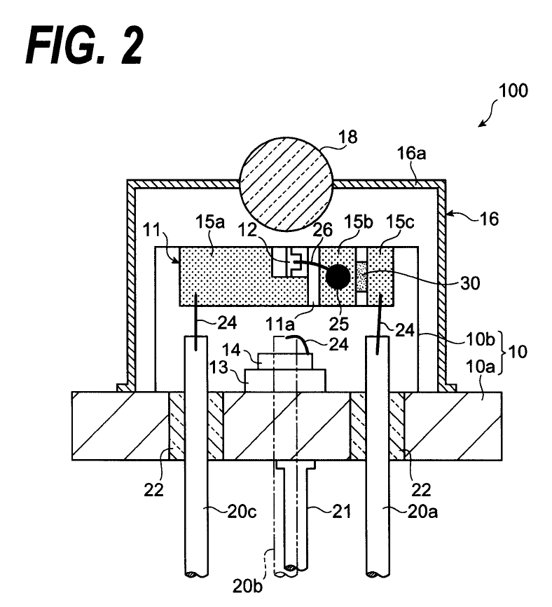

FIG. 1 is a cross section of a semiconductor laser module according to one embodiment of the present invention, where the laser module is viewed form one side, while, FIG. 2 is another cross section of the laser module taken along the line II-II in FIG. 1, where the laser module is viewed from another side perpendicular to that of FIG. 1. The laser module 100 with a co-axial package includes a stem 10, a heat sink 11, a semiconductor laser diode (LD) 12, a semiconductor photodiode (PD) 14, a lens cap 16, a lens 18 and a plurality of lead pins, 20a to 20c, and another lead pin 21.

The stem 10 includes a disk-shaped stem base 10a and a stem block 10b build on an upper surface of the stem base 10a. These stem base 10b and stem block 10b are generally made of metal. The heat sink, which is fixed to the front side of the stem block 10b, provides a surface 11a for mounting the LD 12 thereon. The heat sink conducts and dissipates heat generated by the LD 12 to the stem 10 to cool down the LD 12. Thus, the heat sink is preferably made of material with good thermal conductivity, typically aluminum nitride (AlN).

Under the LD 12 is provided with the PD 14 mounted on the stem base 10a through the sub-mount 13. The PD 14, which is electrically connected to the lead pin 20b with a bonding wire 24, monitors light emitted from a rear facet of the LD 12 and outputs an electrical signal depending on magnitude of the monitored light to the lead pin 20b.

The lens cap 16 covers the LD 12 and the PD 14 on the upper surface of the stem base 10a. On the ceiling 16a of the lens cap 16 is provided with an aperture into which the spherical lens 18 is fitted. This les 18 concentrates the light emitted from the front facet of the LD 12.

The lead pins, 20a to 20c, passing through the stem base 10a, extrudes into a space formed by the lens cap 16 with the stem base 10a. Each lead pin is fixed to the stem base 10a with a sealant glass 22 that not only electrically isolates the lead pin from the stem 10 but also air-tightly seals the space within the lens cap 16. The lead pin 21 is directly attached to the bottom surface of the stem base 10a to be electrically conducted to the stem 10.

As shown in FIG. 2, the surface 11a of the heat sink 11 where the LD 12 is mounted thereon provides wiring patterns, 15a and 15b, with stacked metals of Ni/Au or Ti/Pt/Au. One end portion of the wiring pattern 15a is connected to the cathode of the LD 12, while, the other end thereof is connected to the lead pin 20c with a bonding wire 24. The other wiring pattern 15b provides a via hole 25 that extends from the top surface 11a to the bottom surface of the heat sink 11. One end of the via hole 25 is connected to the anode of the LD 12 with a bonding wire 26, while, the other end thereof comes in electrically contact to the stem block 10b. Thus, the anode of the LD 12 is electrically connected to the stem block 10b. The wiring pattern 15c extending from the wiring pattern 15b is connected to the other lead pin 20a with a bonding wire 24.

Between the wiring patters, 15b and 15c, on the surface 11a is formed with a resistive element 30, which may be a film resistor provided on the surface 11a. The film resistor may be made of resistive metal such as tantalum nitride (TaN), nickel chromium (NiCr), or copper nickel (CuNi) with sheet resistance thereof from 20 to 100 Ω/square. The sheet resistance means a resistance when the width and the length of the film resistor have a same value. The film resistor 30 of the present embodiment has a dimension, the width and the length thereof, able to generate heat of about 1 Watt, that is, the width and the resistance thereof are about 0.5 mm and from 10 to 50 Ω, respectively. The film resistor 30 may be directly formed by patterning the resistive metal deposited on the surface 11a. For example, a multi-layered metal for the wiring patterns, 15a to 15c, is formed on the whole surface 11a, and the resistive metal, such as TaN, is evaporated and pattered on a predetermined position on the surface 11a of the sub-mount 11.

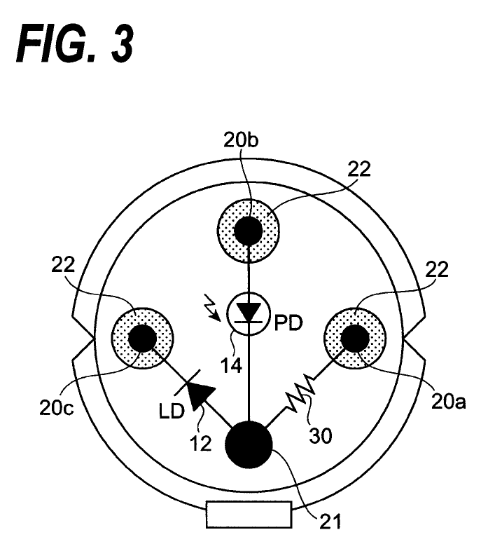

FIG. 3 shows a schematic diagram of the electrical connection within the laser module 100 according to the first embodiment of the invention. The lead pins, 20a to 20c, are connected to the one end of the resistor 30, the anode of the PD 13, and the cathode of the LD 12, respectively. The other end of the resistor 30, the cathode of the PD, and the anode of the LD 12 are commonly connected to the case pin 21.

Supplying a current to the resistor 30 through the lead pin 20a and the case pin 21, the resistor 30 generates heat to increase a temperature of the LD 12. When the laser module 100 is operated in a low temperature, the temperature of the LD 12 may be raised be the heating up of the resistor 30 to compensate the performance of the LD 12. One example is that, assuming the thermal resistance between the outside of the module 100 and the surface 11a, the resistance of the film resistor 30, and the current supplied to the resistor 30 are 30° C./W, 30 Ω, and 200 mA, respectively, the LD 12 may be raised the temperature thereof to 36° C. (=30 [° C./W]×30 [Ω]×0.2² [A²]) at most, which means that the temperature of the LD 12 may be raised higher than the ambient temperature.

Because the film resistor 30 is disposed on the surface 11a with the LD 12, which makes it possible for the resistor 30 close to the LD 12, the efficiency of the heat conductance from the resistor 30 to the LD 12 may be enhanced to facilitate the increase of the temperature of the LD 12. Moreover, the film resistor 30 is not put between the heat sink 11 and the LD 12, which does not cause a degraded heat dissipation of the LD 12.

The film resistor 30 of the present embodiment directly heats up the heat sink 11, which enhances the heating efficiency of the LD 12. Assuming the heat sink is made of AlN and the film resistor is made of TaN with the resistance of 15 Ω, namely, by 0.5 mm×0.15 mm in the dimensions and 50 Ω/square in the sheet resistance thereof, the current supplied to the resistor 30 may be increased to 300 mA at most. In this case, assuming the thermal resistance between the surface 11a and the outside of the module 100 is 30° C./W, a temperature increase of 40° C. can be realized for the heat, 0.3² [A²]×15 [Ω]=1.35 [W], generated by the resistor 30.

Moreover, the film resistor 30 is built within the heat sink 11, which is unnecessary to prepare other components; accordingly, the number of components of the module 100 may be not increased to control the temperature of the LD 12.

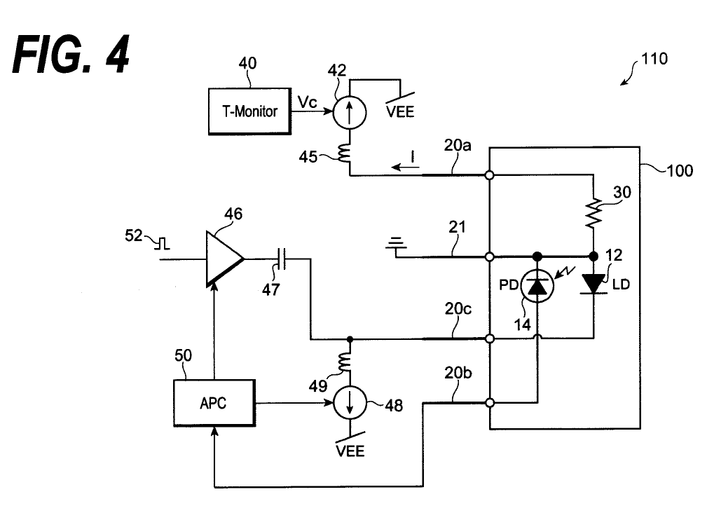

Next, an optical transmitter including the laser module 100 will be described as referring to FIG. 4, which is a schematic block diagram showing the optical transmitter 110 according to the present invention. The optical transmitter 110 includes, adding to the laser module 100, a temperature monitoring block 40, a heater current source 42, a driver 46, a bias current source 48, and an auto power control (APC) circuit 50.

The temperature monitoring block 40 monitors an ambient temperature where the laser module 100 is installed and outputs a signal Vc based on the monitored temperature. The heater current source 42 outputs a current depending on the signal Vc.

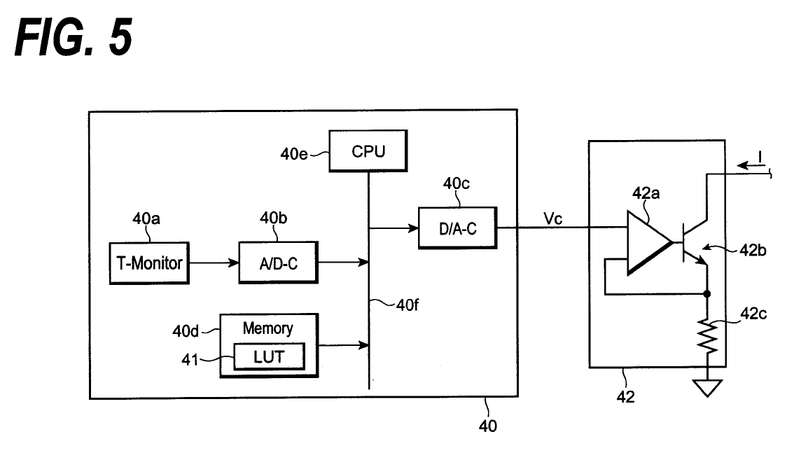

FIG. 5 shows a typical block diagram of the temperature monitoring block 40 and the heater current source 42. In FIG. 5, blocks 40a to 40e denote a temperature monitor, an analog-to-digital converter (A/D-C), a digital-to-analog converter (D/A-C), a memory, and a central processing unit (CPU), respectively. On the other hand, circuit elements 42a to 42c within the heater current source 42 denote an operational amplifier, an npn-transistor, and a resistor, respectively. Within the memory 40d is included with a look-up-table (LUT) 41. These block, 40a to 40e are connected with an internal bus 40f within the temperature monitoring block 40.

As described, the temperature monitor 40a monitors the ambient temperature of the laser module 100 and outputs the signal Vc based on the monitored temperature. A conventional integrated circuit for measuring a temperature or a thermistor may be applicable for the temperature monitor 40a. The A/D-C 40b, by receiving the signal Vc from the temperature sensor 40a in an analog form, converts it to a corresponding digital form. The CPU 40e, by receiving this digital signal, is configured to access the memory 40d and to refer the LUT 41 within the memory. The LUT 41 stores a set of digital values each corresponding to a current to be supplied to the film resistor 30 at the temperature sensed by the temperature monitor 40a. That is, the LUT configures addresses corresponding to values output from the A/D-C 40b and a value stored in a specific address corresponding to a current to be supplied to the film resistor 30. The CPU 40e is configured to read a control value corresponding to the ambient temperature that is output from the A/D-C 40b and to output the control value to the D/A-C 40c. The D/A-C 40c converts this digital signal into the analog signal Vc.

When no value corresponding to an output value provided from the A/D-C 40b is found, another value nearest to the output provided from the A/D-C 40b may be applicable. Or, an estimated value may be applicable by an extrapolation or an interpolation of addresses in the LUT 41 and the output value from the A/D-C 40b.

The control signal Vc is led to one of inputs of the amplifier 42a. The other input receives a voltage induced in a resistor 42c. Since the operational amplifier 42a outputs or control a transistor 42b connected to the output terminal of the operational amplifier 42a so as to equalize two inputs of the operational amplifier 42a, namely, the emitter voltage of the transistor 42b becomes equal to the control signal Vc. Because the emitter voltage is determined by a product of the current outgoing from the emitter and the resistance of the resistor 42c, assuming the emitter current substantially equal to the collector current, namely, ignoring the base current because of its magnitude far smaller than the collector current and the emitter current, the current flowing in the collector can be determined by the control signal Vc.

Thus, the heater current source 42 generates the current I determined by the control signal Vc. The heater current source 42 is coupled with the lead pin 20a via an inductor 45, accordingly, the current I generates heat at the film resistor 30 flowing therein via the lead pin 20a.

The driver 46, by receiving a modulation signal 42, generates a driving signal. The driving signal is supplied to the lead pin 20c via a capacitor 47. Between the capacitor 47 and the lead pin 20c is connected with a bias current source 48 via an inductor 49. A signal in which the modulation current based on the driving signal 52 superposed with the bias current is supplied to the LD 12 via the lead pin 20c to drive the LD 12. The APC circuit 50, connected to the lead pin 20b, controls the driver 46 and the bias current source 48 so as to have the optical output from the LD 12 stable based on the output from the PD 14.

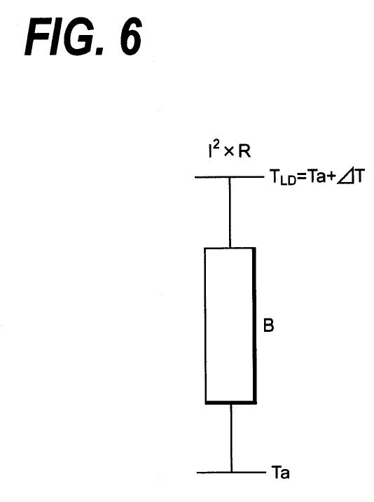

Next, the magnitude of the current I to be supplied to the film resistor 30 will be considered as referring to FIG. 6 that shows a thermal balance of the laser module 100. The LD 12 is thermally coupled with the ambient via a thermal resistor B, namely, the temperature T_{LD} of the LD 12 is determined by the ambient temperature Ta and the thermal resistor B. The LD 12 receives heat, quantity of which is denoted as I²×R, from the film resistor 30 arranged just near the LD 12, which raises the temperature of the LD 12 by ΔT with respect to the ambient temperature Ta.

The present embodiment, when the ambient temperature Ta is below a specific temperature Th, supplies the current I to the film resistor 30. A relation of the current I with respect to the ambient temperature Ta is given by:
I=A×(Th−Ta)^{1/2} (1),
where A is a constant. Supplying the current I given by the equation (1) to the film resistor 30, the temperature of the LD 12 may be maintained a critical temperature T_{LDh} even when the ambient temperature becomes lower than a specific temperature Th, where T_{LDh} is the temperature at which the ambient temperature Ta becomes equal to the specific temperature Th.

The present embodiment, taking the capacity of the film resistor 30 into account, supplies the current I defined by the equation (1) to the film resistor 30 only when the ambient temperature Ta is within a preset range. The higher limit of the preset range is the specific temperature Th mentioned above. Denoting the lower limit of the preset range Tl and the current flowing in the film resistor 30 when the ambient temperature Ta is at the lower limit Tl as I (Tl), which is determined by the equation (1), the current I is maintained to I(Tl) when the ambient temperature Ta becomes lower than the limit Tl.

The current I supplied to the film resistor 30 may be controlled by, monitoring the ambient temperature Ta with a temperature sensor such as thermistor, and processing the output from the sensor by an analog circuit, or preferably by a digital circuit. The digital processing of the sensed temperature and the control of the current by thus processed temperature may be simply carried out by a circuit shown in FIG. 5. The LUT 41, namely, the LUT may store the magnitude of the current I calculated by the equation (1) in connection with the ambient temperature Ta.

Another method may be applicable, in which the current I is fully controlled by a logic circuit. For instance, setting several parameters, such as the lower limit Tl, the higher limit Th, the thermal resistance B, and the current at the lower limit I (Tl) in respective resistors, and calculating the current at the upper higher limit Th as I=A×{Th−Ta}^{1/2}, the current supplied to the film resistor 30 is selected based on the ambient temperature. That is, when the ambient temperature is higher than the higher limit Th, no current is supplied to the resistor 30, the current with the magnitude I (Tl) is supplied when the ambient temperature Ta is lower than the lower limit Tl, and a current I calculated by the equation is supplied thereto when the ambient temperature is between the lower and the higher limit. When the ambient temperature lower than the lower limit Tl, which means lack of the heater capacity, the temperature of the LD 12 decreases as decreasing the ambient temperature.

According to the present optical transmitter 110, the temperature of the LD 12 may be maintained within a preset range by monitoring the ambient temperature and adjusting the current I supplied to the film resistor 30 based on the ambient temperature, even when the ambient temperature is lower than the lower limit Tl. In particular, when the ambient temperature is within the specific range, namely, between the lower and the higher limits, the temperature of the LD 12 may be substantially constant.

For example, assuming an operating temperature of the LD 12 is between −20° C. to +85° C., the thermal resistance between the surface 11a of the heat sink 11 and the ambient is 40° C./W, the resistance of the film resistor 30 is 15 Ω, the maximum current supplied to the resistor 30 is 200 mA, and the higher Th and the lower Tl limits of the ambient temperature are +4° C. and −20° C., respectively, then the operating temperature of the LD 12 can be maintained at +4° C. by supplying the current obeying the quadratic relation shown in the equation (1) in the range from −20° C. to +4° C. This means that the operating temperature of the LD 12 may be narrowed from a condition, −20° C. to +85° C. (ΔT=105° C., to another condition, +4° C. to +85° C. (ΔT=81° C.), which may relax the electrical operating condition and improve the performance of the LD 12.

The current I supplied to the film resistor 30 is preferably smaller than 400 mA. A smaller current is unable to raise the temperature of the LD 12, while, a larger current follows a higher power supply voltage to drive the heater current source 42 because of the larger voltage drop in the film resistor 30.

### Second Embodiment

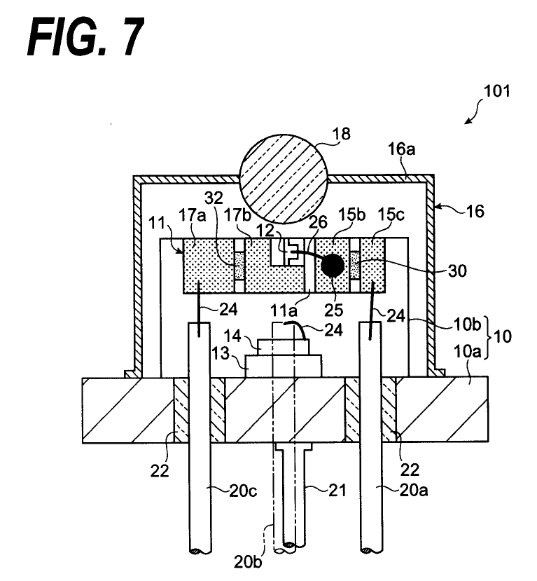

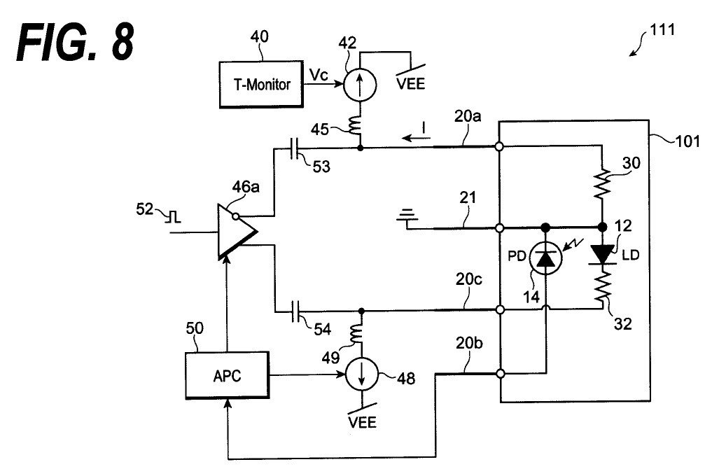

FIG. 7 is a cross sectional view showing another laser module 101 according to the second embodiment of the invention, while, FIG. 8 is a circuit diagram of the laser module. This module 101 provides, substituting the metal wiring 15a in the previous module shown in FIG. 1, two metal wirings, 17a and 17b, and a resistor 32. Other configurations of the module 101 are same with or equivalent to those shown in the first embodiment.

One metal wiring 17a is connected to the lead pin 20c via a bonding wire 24, while, the other wiring 17b is connected to the cathode of the LD 12. The resistor 32 is put between these wirings, 17a and 17b. Similar to the film resistor 30, the resistor 32 has a configuration of the film resistor and directly put on the surface 11a of the heat sink 11.

In the present embodiment, the resistor 32 is put between the wirings, 17a and 17b, accordingly, the impedance mismatching between the LD 12 and the driver 46 may be decreased, which improves the degradation in the waveform due to the impedance mismatching. Moreover, the resistor 32 is directly attached to the surface 11a, no additional components are required to form the resistor on the heat sink, which enhances the assembling capability.

### Third Embodiment

FIG. 8 is a circuit diagram of an optical transmitter 111 according to the third embodiment of the invention. This optical transmitter 111 provides, instead of the driver 46 and the capacitor 47 in the previous embodiment, another form of the driver 46a and two capacitors, 53 and 54. Moreover, the optical transmitter 111 provides anther laser module 101.

The optical transmitter 111 generates a driving signal in a differential form to drive the LD 12. The driver 46a provides two outputs, one is for a normal phase signal and the other of which is for a reverse phase signal. One output is coupled with the lead pin 20a via the capacitor 53, while the other is coupled with another lead pin 20c via the other capacitor 54. Thus, one electrode of the LD 12 is provided with a modulation signal, while, the other electrode thereof is provided with another signal, the phase of which is just opposite to that appeared in the LD 12. The film resistor 30 in the present embodiment operates as a termination resistor. Thus, the present embodiment may lower common impedance for the ground to enhance the high frequency performance of the laser module 101.

Thus, the present invention is described as referring to embodiments and accompanying drawings. However, the invention is not limited to those embodiments and may have various variations without apart from subjects of the invention. For example, the resistor attached to the surface of the heat sink may be is not limited to a film resistor, another configuration of the resistor such as ______ may be applicable. Moreover, in the embodiments, the optical transmitter 110 provides the laser module 100, while the other transmitter 111 provides the laser module 101. However, the transmitter 110 may provide the module 101, while, the transmitter 111 may provide the module 100. It is therefore contemplated that the appended claims will cover any such modifications or embodiments as may fall within the scope of the invention defined by the following claims and their equivalents.

What is claimed is:

1. A semiconductor laser module, comprising:
a semiconductor laser diode;
a heat sink that mounts the semiconductor laser diode thereon, the heat sink being made of an insulating material;
a heater formed directly on a surface of the heat sink; and
a co-axial package for installing the semiconductor laser diode, the heat sink, and the heater therein.

2. The semiconductor laser module according to claim 1,
wherein the heat sink is made of aluminum nitride and the heater is made of tantalum nitride.

3. The semiconductor laser module according to claim 1,
wherein the co-axial package includes a stem base and a stem block protruding from the stem base, the stem base and the stem block being made of metal, and
wherein the heat sink is mounted on the stem block.

4. The semiconductor laser module according to claim 3,
wherein the stem base includes a plurality of lead pins and the heat sink provides at least two wiring patterns putting the heater therebetween, one of lead pins directly and electrically connected to the stem base and
wherein the one of wiring patterns extends the heater therefrom, connects the semiconductor laser diode with a bonding wire, and is directly connected to the stem block with a via hole.

5. A method for controlling a temperature of a semiconductor laser diode installed within a laser module that provides a heater and a heat sink for arranging the heater directly on a surface thereof, the method comprising steps of:
monitoring an ambient temperature of the laser module;
deciding whether the ambient temperature is within a preset temperature range; and
supplying a current to the heater when the ambient temperature is within the preset temperature range.

6. The method according to claim 5,
wherein the current supplied to the heater is determined by an equation;
I=A×(Th−Ta)^{1/2},
where I is the current supplied to the heater, A is a constant, Th is a higher limit of the preset temperature range, and Ta is the ambient temperature.

7. The method according to claim 6,
wherein the current supplied to the heater saturates at a magnitude of A×(Th−Tl)^{1/2} when the ambient temperature is below the lower limit Tl of the preset temperature range.

8. The method according to claim 5,
wherein the monitor of the ambient temperature is performed by a temperature sensor placed outside of the laser module.

9. The method according to claim 5,
wherein the step for supplying the current to the heater includes steps of:
accessing a memory that stores a relation of currents to be supplied to the heater with respect to temperatures, and
getting a current corresponding to the ambient temperature from the memory, and
supplying the current gotten from the memory to the heater.

10. The method according to claim 6,
wherein the step for getting the current includes an extrapolation and/or an interpolation of the currents stored in the memory with respect to the ambient temperature.
